(19) United States
(12) Patent Application Publication
(10) Pub. No.: US 2006/0279765 A1
(43) Pub. Date: Dec. 14, 2006

(54) Image forming apparatus

(75) Inventor: Hiroshi Eguchi, Tokyo (JP)

Correspondence Address: TAKEUCHI & KUBOTERA, LLP, SUITE 202, 200 DAINGERFIELD ROAD, ALEXANDRIA, VA, 22314, US

(73) Assignee: Oki Data Corporation

(21) Appl. No.: 11/448,711

(22) Filed: Jun. 8, 2006

(30) Foreign Application Priority Data
Jun. 10, 2005 (JP) 2005-171028

(51) Int. Cl. G06K 15/00

(52) U.S. Cl. 358/1.14

(57) ABSTRACT

An image forming apparatus receives print data per a print job from an external device, and stores the print data. Then, the image forming apparatus performs a printing operation in a specific printing order. The image forming apparatus comprises: a print alarm detection unit for detecting a print interruption cause; a job selection unit for selecting a print job to be resumed after the print interruption cause detected by the print alarm detection unit is removed; and a printing order setting unit for setting a printing order when the print job selected by the job selection unit is different from the specific printing order. The image forming apparatus may further include a job regeneration unit for regenerating one print job according to print data of a print job not printed when the print interruption cause is generated during the print job.

### BACKGROUND OF THE INVENTION AND RELATED ART STATEMENT

The present invention relates to an image forming apparatus, especially to an image forming apparatus capable of selecting a print job to be performed after a print alarm is deactivated.

An image forming device may be connected to a network for receiving data per a print job for a printing operation from a plurality of host computers. In this case, when a sheet tray retaining sheets necessary for the printing operation is not installed, the printing operation is interrupted during executing the print job. In a conventional image forming apparatus, even though a sheet tray retaining sheets necessary for a subsequent operation is installed, the printing operation is stopped and the subsequent operation will not be performed.

To this end, it has been proposed that an image forming apparatus is capable of performing a subsequent operation even when a precedent operation is interrupted, if a cause of the interruption does not prevent the subsequent operation from being performed (refer to Patent Reference). In Patent Reference, it is limited to the technology for removing a cause of interruption per a print job.

In a conventional image forming apparatus (including the one disclosed in Patent Reference), when an alarm is activated due to a cause such as no sheet during a print job, the printing operation is resumed from print data not printed after the alarm is deactivated. In this case, even though the printing operation to be resumed is not urgent, the printing operation is automatically resumed after the alarm is deactivated. Therefore, when an alarm is activated and left in the activated state for a while, another person with an urgent printing job has to deactivate the alarm and wait until the remaining printing operation is complete. Patent Reference: Japanese Patent Publication No. 11-134122

In view of the problems described above, an object of the present invention is to provide an image forming apparatus capable of selecting a print job to be performed after a print alarm is deactivated when the print alarm is activated.

Further objects and advantages of the invention will be apparent from the following description of the invention.

### SUMMARY OF THE INVENTION

In order to attain the objects described above, according to the present invention, an image forming apparatus receives print data per a print job from an external device, and stores the print data. Then, the image forming apparatus performs a printing operation in a specific printing order. The image forming apparatus comprises: a print alarm detection unit for detecting a print interruption cause; a job selection unit for selecting a print job to be resumed after the print interruption cause detected by the print alarm detection unit is removed; and a printing order setting unit for setting a printing order when the print job selected by the job selection unit is different from the specific printing order. The image forming apparatus may further include a job regeneration unit for regenerating one print job according to print data of a print job not printed when the print interruption cause is generated during the print job. Further, the printing order setting unit sets the print job regenerated by the job regeneration unit according to the print data of the print job not printed in an order after a print job to be resumed when the job selection unit selects the order of print jobs to be printed different from the specific printing order.

In the invention, when the print alarm is activated, the image forming apparatus is capable of selecting a print job to be performed after a print alarm is deactivated, thereby improving operation efficiency.

### BRIEF DESCRIPTION OF THE DRAWINGS

FIG. 1 is a schematic block diagram showing a printer device according to a first embodiment of the present invention;

FIG. 2 is a schematic view showing a print engine;

FIG. 3 is a flow chart showing a process of the printer device according to the first embodiment of the present invention;

FIG. 4 is a view showing an LCD display panel;

FIG. 5 is a schematic block diagram showing a printer device according to a second embodiment of the present invention;

FIG. 6 is a flow chart showing a process of the printer device according to the second embodiment of the present invention;

FIG. 7 is a schematic block diagram showing a printer device according to a third embodiment of the present invention;

FIG. 8 is a flow chart showing a process of the printer device according to the third embodiment of the present invention;

FIGS. 9(a) to 9(c) are views showing examples of a printing order; and

FIGS. 10(a) to 10(c) are schematic views showing configurations of a printer device having a notification unit.

### DETAILED DESCRIPTION OF PREFERRED EMBODIMENTS

Hereunder, embodiments of the present invention will be explained with reference to the accompanying drawings.

First Embodiment

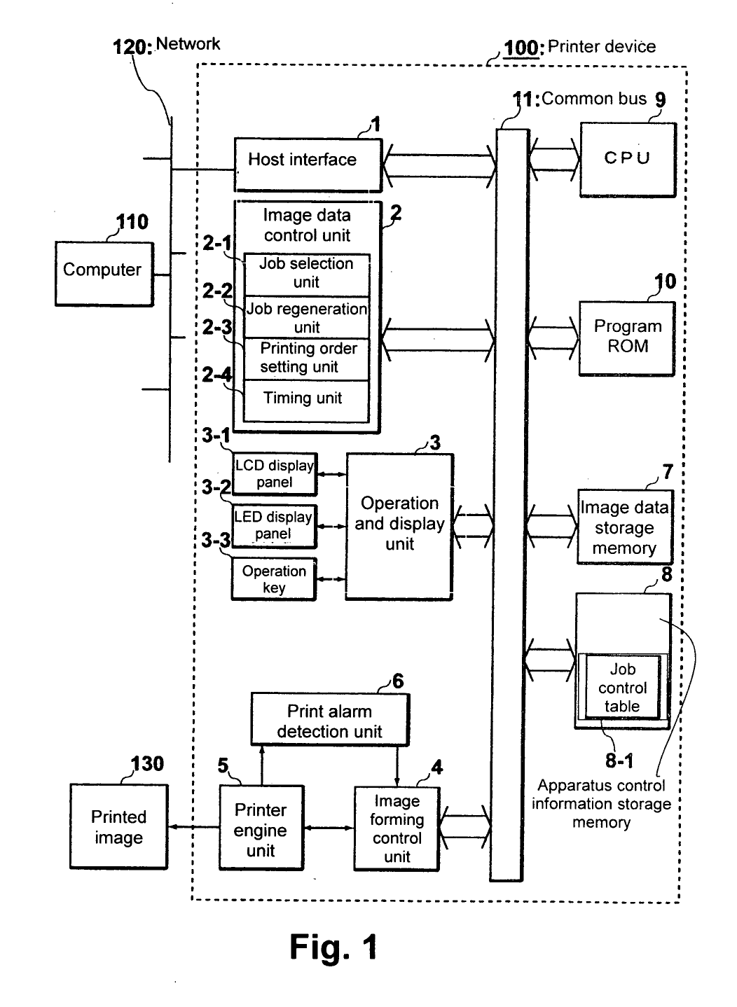

FIG. 1 is a schematic block diagram showing a printer device or an image forming apparatus 100 according to a first embodiment of the present invention. As shown in FIG. 1, the printer device 100 includes a host interface 1; an image data control unit 2; an operation and display unit 3; an image forming control unit 4; a printer engine unit 5; a print alarm detection unit 6; an image data storage memory 7; an apparatus control information storage memory 8; a CPU 9; and a program ROM 10.

The host interface 1 receives print data per a print job from an external device (computer 110) through a network 120. The host interface 1 connects the network 120 and the printer device 100 according to a specific protocol.

The image data control unit 2 monitors a print job, and includes a job selection unit 2-1; a job regeneration unit 2-2; a printing order setting unit 2-3; and a timing unit 2-4. The job selection unit 2-1 prompts an operator to select a print job to be resumed through the operation and display unit 3 after a print interruption cause is removed, and receives the selection. When the print interruption cause is generated during a specific print job, the job regeneration unit 2-2 regenerates one print job according to print data of the print job not printed. The printing order setting unit 2-3 sets the print job regenerated according to the print data of the print job not printed in an order after a print job to be resumed when the job selection unit 2-1 selects the order of print jobs different from a specific printing order. The timing unit 2-4 measures a delay time until receipt of the selection when the job selection unit 2-1 prompts an operator to select a print job to be resumed through the operation and display unit 3. The timing unit 2-4 detects time-out after a specific period of time.

The image data control unit 2 writes and reads a print job into and from the image data storage memory 7, and transfers the print job to the image forming control unit 4. When the print alarm detection unit 6 detects a print interruption cause, the image data control unit 2 stops transferring the print job to the image forming control unit 4. The image data control unit 2 is started when the CPU 9 executes a specific control program stored in the program ROM 10. The print interruption cause includes no sheet, sheet jam, or the like, with which it is difficult to continue a printing operation. When the print interruption cause is removed, it is possible to resume the printing operation.

The operation and display unit 3 includes an LCD display panel 3-1; an LED display panel 3-2; and an operation key 3-3. The operation and display unit 3 displays a status of the apparatus, information regarding a print job, and the like for an operator. The operation and display unit 3 also functions as a man-machine interface between an operator and the printer device 100 for receiving a command of the operator. The operation and display unit 3 starts the display function for the operator and the interface display function relative to the operator upon controlling the job selection unit 2-1 when the CPU 9 executes a specific control program stored in the program ROM 10.

The image forming control unit 4 receives a print job from the image data control unit 2, and controls the printer engine unit 5 to perform the printing operation. The image forming control unit 4 also receives a notice of print interruption cause such as no sheet or sheet jam from the print alarm detection unit 6, so that the image forming control unit 4 sends an alarm signal to the image data control unit 2 and the operation and display unit 3. Further, the image forming control unit 4 receives a removal notice of print interruption cause to stop sending the alarm signal. The image forming control unit 4 is started when the CPU 9 executes a specific control program stored in the program ROM 10.

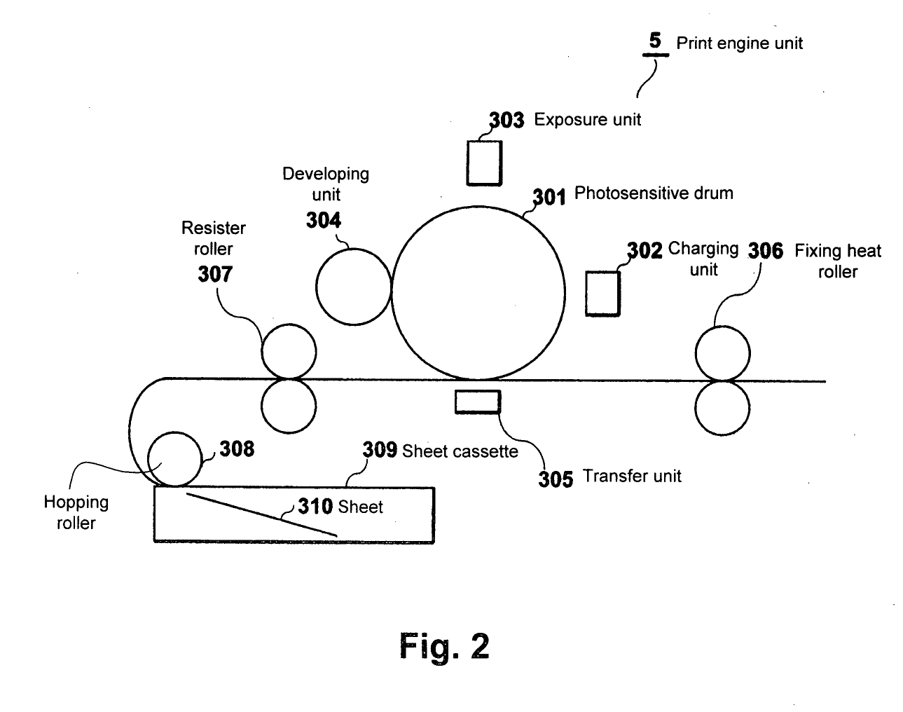

The printer engine unit 5 performs the printing operation according to the control of the image forming control unit 4. FIG. 2 is a schematic view showing the print engine unit 5. As shown in FIG. 2, the printer engine unit 5 includes a photosensitive drum 301; a charging unit 302; an exposure unit 303; a developing unit 304; a transfer unit 305; a fixing heat roller 306; a resister roller 307; a hopping roller 308; and a sheet cassette 309.

When the hopping roller 308 transports a sheet 310 from the sheet cassette 309, the resister roller 307 transports the sheet 310 from a left side to a right side in FIG. 2. After the charging unit 302 uniformly charges a surface of the photosensitive drum 301, the exposure nit 303 irradiates the photosensitive drum 301 to form a latent image. The developing unit 304 supplies toner to the latent image to visualize the latent image as a toner image. The transfer unit 305 transfers the toner image to the sheet 310 transported. The fixing heat roller 306 heats the toner image on the sheet 310, so that a printed image 130 is melt and fixed on the sheet 310 (FIG. 1).

The print alarm detection unit 6 monitors various sensors disposed at specific positions of the printer engine unit 5, and detects the print interruption cause such as no sheet or sheet jam, so that the print alarm detection unit 6 sends the notice of print interruption cause to the image forming control unit 4. The print alarm detection unit 6 also sends the removal notice of print interruption cause to the image forming control unit 4 when the print interruption cause is removed.

The image data storage memory 7 is a memory capable of storing a plurality of print jobs (print data). The image data control unit 2 writes and reads the print jobs into and from the image data storage memory 7. When the printer device 100 receives the print job from the external device (computer 120) through the network 120, the print job is temporarily stored in the image data storage memory 7. The print job is deleted after the printing operation is performed.

The apparatus control information storage memory 8 is a memory for storing information regarding an operation of the apparatus as a whole. The image data control unit 2 writes and reads the information regarding a control operation into and from the apparatus control information storage memory 8 through a common bus 11. The apparatus control information storage memory 8 includes a job control table 8-1, and stores information of the print job (host name, file name, IP address, etc.) and a storage state (the number of stored jobs, a printing order of the stored jobs, etc.) in a transmitted order or a printing order.

The CPU 9 is a microprocessor for controlling the whole apparatus. In the embodiment, the CPU 9 executes control programs stored in the program ROM 10 to start the image data control unit 2, the operation and display unit 3, and the image forming control unit 4.

The program ROM 10 is a read-only memory for storing the control programs to be executed by the CPU 9 for controlling the whole apparatus. In the embodiment, the CPU 9 executes the control programs stored in the program ROM 10 in advance to start the image data control unit 2, the operation and display unit 3, and the image forming control unit 4.

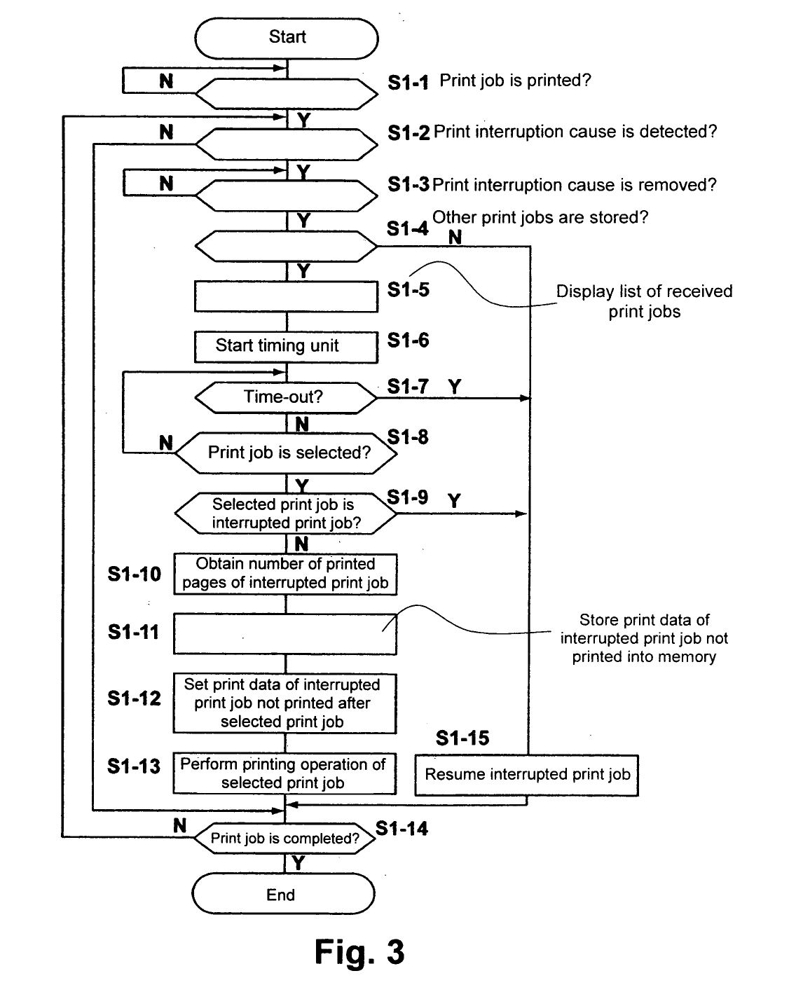

The printing operation of the printer device 100 according to the first embodiment is performed as follows. FIG. 3 is a flow chart showing the process of the printer device 100 according to the first embodiment of the present invention. The print operation of the printer device 100 will be explained in detail from step S1-1 to step S1-15.

In step S1-1, when the printer engine unit 5 (FIG. 1) performs specific print jobs in an order defined by the job control table 8-1 (FIG. 1), the process proceeds to step S1-2. In step S1-2, unless the print alarm detection unit 6 (FIG. 1) detects the print interruption cause during the printing operation, the process proceeds to step S1-14. When the print alarm detection unit 6 (FIG. 1) detects the print interruption cause (for example, no sheet), the image forming control unit 4 (FIG. 1) sends the alarm signal to the image data control unit 2 and the operation and display unit 3. Then, the process proceeds to step S1-3.

In step S1-3, the image data control unit 2 (FIG. 1) stops sending the print job, and waits for termination of the alarm signal. When the operator removes the print interruption cause (for example, the operation replenishes sheets) according to the display of the operation and display unit 3 (FIG. 1), the print alarm detection unit 6 (FIG. 1) sends the removal notice of print interruption cause to the image forming control unit 4 (FIG. 1). Then, the image forming control unit 4 stops sending the alarm signal, and the process proceeds to step S1-4.

In step S1-4, the image data control unit 2 (FIG. 1) looks up the job control table 8-1 (FIG. 1) and determines whether other print jobs are stored in the image data storage memory 7 (FIG. 1). When other print jobs are not stored, the process proceeds to step S1-15. When other print jobs are stored, the process proceeds to step S1-5. In step S1-5, the job selection unit 2-1 (FIG. 1) controls the operation and display unit 3 (FIG. 1) to display contents of the job control table 8-1 (FIG. 1) on the LCD display panel 3-1 (FIG. 1), and prompts the operator to select a print job to be resumed.

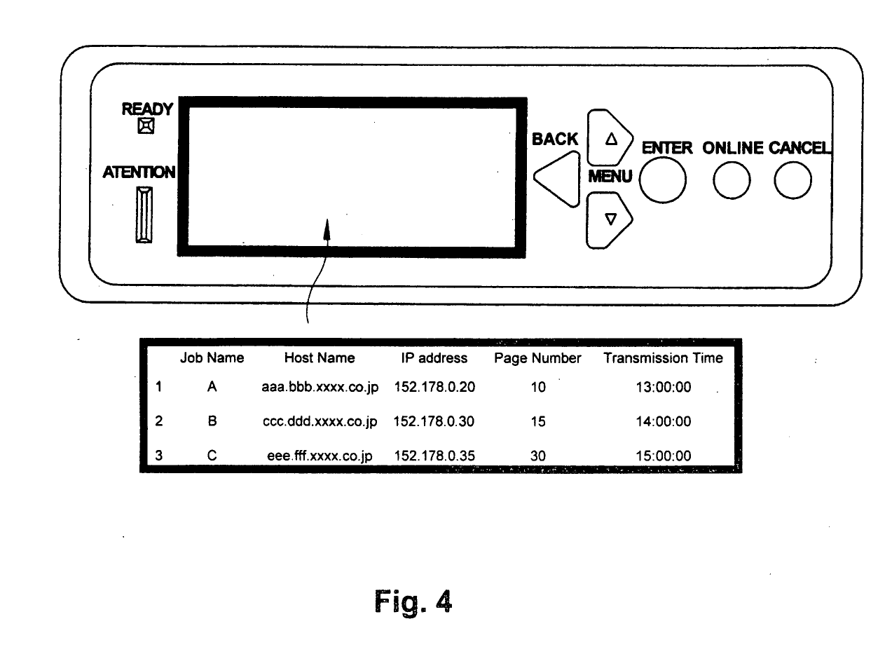

An example displayed on the LCD display panel 3-1 (FIG. 1) will be explained. FIG. 4 is a view showing the LCD display panel 3-1. In FIG. 4, the contents of the job control table 8-1 (FIG. 1) are displayed on the LCD display panel 3-1, so that the operator is prompted to select a print job to be resumed. Names of the print jobs stored in the image data storage memory 7 (FIG. 1) are displayed in the printing order from the top, and an arrow on the right side represents the print job selected. The operator moves the arrow through keys above and below “MENU” to select the print job, and pushes “ENTER” to finalize the selection.

In step S1-6, the timing unit 2-4 (FIG. 1) starts measuring the delay time until receipt of the selection of the print job to be resumed. In step S1-7, until the timing unit 2-4 (FIG. 1) becomes time-up, the process proceeds to step S1-8. When the timing unit 2-4 (FIG. 1) becomes time-up, the process proceeds to step S1-15. In step S1-8, the process waits until receipt of the selection of the print job to be resumed. Upon receipt, the process proceeds to step S1-9. In step S1-9, when the print job selected is the print job interrupted due to the alarm, the process proceeds to step S1-15. Otherwise, the process proceeds to step S1-10.

In step S1-10, the job regeneration unit 2-2 (FIG. 1) obtains the number of pages already printed in the print job interrupted through the image forming control unit 4 (FIG. 1). In step S1-11, the job regeneration unit 2-2 (FIG. 1) regenerates a print job according to print data not printed in the print job interrupted, and stores the print job regenerated in the image data storage memory 7 (FIG. 1). At this moment, the print job interrupted is deleted from the image data storage memory 7 (FIG. 1) and the job control table 8-1.

In step S1-12, the printing order setting unit 2-3 (FIG. 1) sets the print job regenerated in the printing order after the print job selected from the print jobs other than the print job interrupted by the operator, and writes the print job regenerated into the job control table 8-1 (FIG. 1). In step S1-13, the image data control unit 2 (FIG. 1) reads the specific print jobs according to the job control table 8-1 (FIG. 1) set in step S1-12, and sends the specific print jobs to the image forming control unit 4 (FIG. 1). Upon receipt of the specific print jobs, the image forming control unit 4 (FIG. 1) controls the printer engine unit 5 (FIG. 1) to start the printing operation.

In step S1-14, when the printing operation of the print jobs is completed, the process returns to step S1-2 to repeat the printing operation. When the printing operation of all of the print jobs stored in the image data storage memory 7 (FIG. 1) is completed, the process stops. In step S1-15, the image data control unit 2 (FIG. 1) reads the print data not printed in the print job interrupted, and sends the print data to the image forming control unit 4 (FIG. 1). Upon receipt of the print data, the image forming control unit 4 (FIG. 1) controls the printer engine unit 5 (FIG. 1) to resume the printing operation. Then, the process proceeds to step S1-14, and the process stops.

As described above, when the alarm is activated due to the print interruption cause such as no sheet during the print job, if the printing operation to be resumed is not urgent, it is possible to select and resume another urgent printing job after the alarm is deactivated, thereby improving printing efficiency.

Second Embodiment

In the first embodiment, after the alarm is deactivated, the printing operation is resumed from the print job selected by the operator. In the second embodiment, when the number of pages not printed is less than a specific number defined in advance upon generation of the alarm, the pages not printed have priority over the print job selected by the operator and are printed before the print job selected. Hereunder, only differences from the first embodiment will be explained. Components same as those in the first embodiment are designated by the same reference numerals, and explanations thereof are omitted.

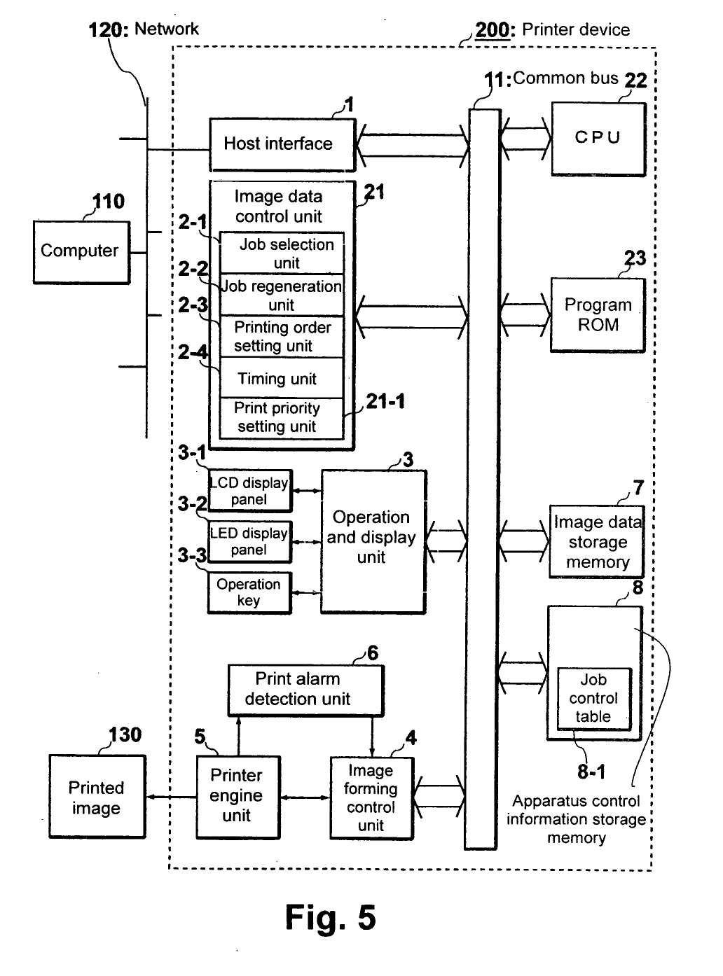

FIG. 5 is a schematic block diagram showing a printer device 200 according to the second embodiment of the present invention. As shown in FIG. 5, the printer device 200 includes the host interface 1; an image data control unit 21; the operation and display unit 3; the image forming control unit 4; the printer engine unit 5; the print alarm detection unit 6; the image data storage memory 7; the apparatus control information storage memory 8; a CPU 22; and a program ROM 23.

The image data control unit 21 monitors a print job, and includes the job selection unit 2-1; the job regeneration unit 2-2; the printing order setting unit 2-3; the timing unit 2-4 and a print priority setting unit 21-1. The job selection unit 2-1 prompts an operator to select a print job to be resumed through the operation and display unit 3 after a print interruption cause is removed, and receives the selection. The job regeneration unit 2-2 regenerates one print job according to print data of a print job not printed when the print interruption cause is generated during the print job. The printing order setting unit 2-3 sets the print job regenerated according to the print data of the print job not printed in an order after a print job to be resumed when the job selection unit 2-1 selects the order of print jobs different from a specific printing order. The timing unit 2-4 measures a delay time until receipt of the selection when the job selection unit 2-1 prompts an operator to select a print job to be resumed through the operation and display unit 3. The timing unit 2-4 detects time-out after a specific period of time. The print priority setting unit 21-1 set a printing order of pages not printed have before the print job selected by the operator when the number of the pages not printed is less than a limit page number defined in advance upon generation of the alarm.

The image data control unit 21 writes and reads a print job into and from the image data storage memory 7, and transfers the print job to the image forming control unit 4. When the print alarm detection unit 6 detects a print interruption cause, the image data control unit 21 stops transferring the print job to the image forming control unit 4. The image data control unit 21 is started when the CPU 22 executes a specific control program stored in the program ROM 23. The print interruption cause includes no sheet, sheet jam, or the like, with which it is difficult to continue the printing operation. When the print interruption cause is removed, it is possible to resume the printing operation.

The CPU 22 is a microprocessor for controlling the whole apparatus. In the embodiment, the CPU 22 executes control programs stored in the program ROM 23 to start the image data control unit 21, the operation and display unit 3, and the image forming control unit 4.

The program ROM 23 is a read-only memory for storing the control programs to be executed by the CPU 22 for controlling the whole apparatus. In the embodiment, the CPU 22 executes the control programs stored in the program ROM 23 in advance to start the image data control unit 21, the operation and display unit 3, and the image forming control unit 4.

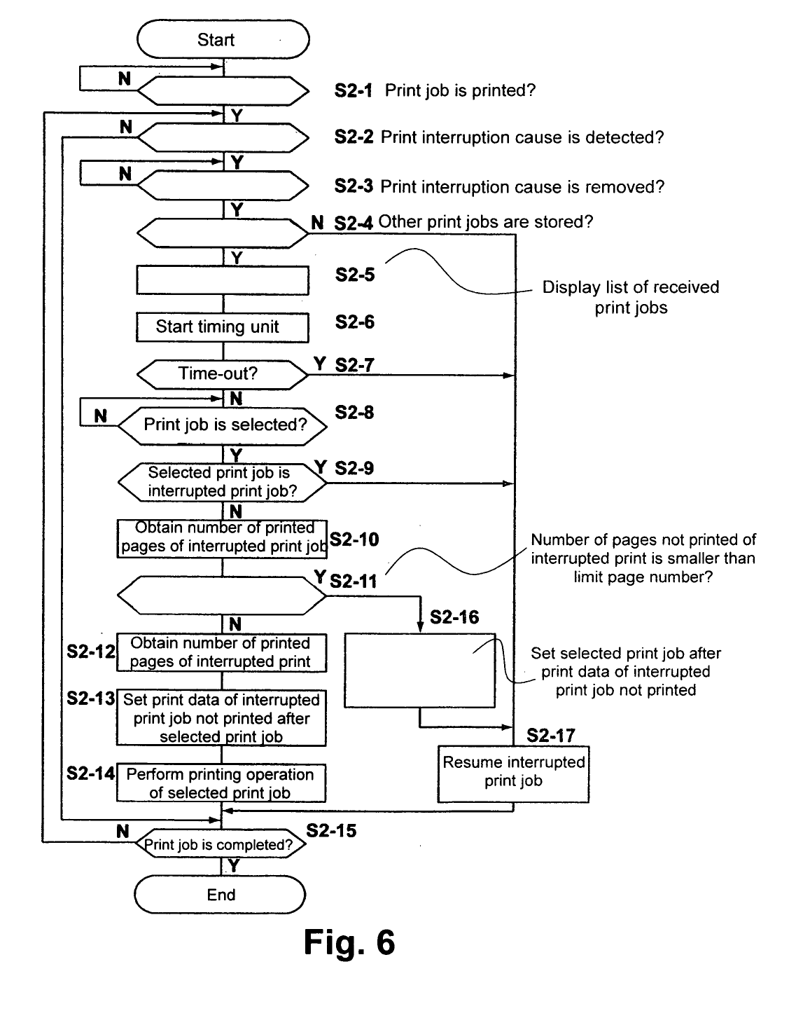

The printing operation of the printer device 200 according to the second embodiment is performed as follows. FIG. 6 is a flow chart showing the process of the printer device 200 according to the second embodiment of the present invention. The print operation of the printer device 200 will be explained in detail from step S2-1 to step S2-17.

In step S2-1, when the printer engine unit 5 (FIG. 5) performs specific print jobs in an order defined by the job control table 8-1 (FIG. 5), the process proceeds to step S2-2. In step S2-2, unless the print alarm detection unit 6 (FIG. 5) detects the print interruption cause during the printing operation, the process proceeds to step S2-15. When the print alarm detection unit 6 (FIG. 5) detects the print interruption cause, a notice of print interruption cause is sent to the image forming control unit 4 (FIG. 5), so that the image forming control unit 4 (FIG. 5) sends the alarm signal to the image data control unit 21 (FIG. 5) and the operation and display unit 3 (FIG. 5). Then, the process proceeds to step S2-3.

In step S2-3, the image data control unit 21 (FIG. 5) stops sending the print job, and waits for termination of the alarm signal. When the operator removes the print interruption cause according to the display of the operation and display unit 3 (FIG. 5), the print alarm detection unit 6 (FIG. 5) sends the removal notice of print interruption cause to the image forming control unit 4 (FIG. 5). Then, the image forming control unit 4 (FIG. 5) stops sending the alarm signal, and the process proceeds to step S2-4.

In step S2-4, the image data control unit 21 (FIG. 5) looks up the job control table 8-1 (FIG. 5) and determines whether other print jobs are stored in the image data storage memory 7 (FIG. 5). When other print jobs are not stored, the process proceeds to step S2-17. When other print jobs are stored, the process proceeds to step S2-5. In step S2-5, the job selection unit 2-1 (FIG. 5) controls the operation and display unit 3 (FIG. 5) to display contents of the job control table 8-1 (FIG. 5) on the LCD display panel 3-1 (FIG. 5), and prompts the operator to select a print job to be resumed.

In step S2-6, the timing unit 2-4 (FIG. 5) starts measuring the delay time until receipt of the selection of the print job to be resumed. In step S2-7, until the timing unit 2-4 (FIG. 5) becomes time-up, the process proceeds to step S2-8. When the timing unit 2-4 (FIG. 5) becomes time-up, the process proceeds to step S2-17. In step S2-8, the process waits until receipt of the selection of the print job to be resumed. Upon receipt, the process proceeds to step S2-9. In step S2-9, when the print job selected is the print job interrupted due to the alarm, the process proceeds to step S2-17. Otherwise, the process proceeds to step S2-10.

In step S2-10, the job regeneration unit 2-2 (FIG. 5) obtains the number of pages already printed in the print job interrupted through the image forming control unit 4 (FIG. 5). In step S2-11, the print priority setting unit 21-1 (FIG. 5) compares the number of pages not printed in the print job interrupted with a limit page number (for example, one page) defined in advance. When the number of pages not printed is smaller than the limit page number, the process proceeds to step S2-16. Other wise, the process proceeds to step S2-12.

In step S2-12, the job regeneration unit 2-2 (FIG. 5) regenerates a print job according to print data not printed in the print job interrupted, and stores the print job regenerated in the image data storage memory 7 (FIG. 5). At this moment, the print job interrupted is deleted from the image data storage memory 7 (FIG. 5) and the job control table 8-1. In step S2-13, the printing order setting unit 2-3 (FIG. 5) sets the print job regenerated in the printing order after the print job selected from the print jobs other than the print job interrupted by the operator, and writes the print job regenerated into the job control table 8-1 (FIG. 5).

In step S2-14, the image data control unit 21 (FIG. 5) reads the specific print jobs according to the job control table 8-1 (FIG. 5) set in step S2-13, and sends the specific print jobs to the image forming control unit 4 (FIG. 5). Upon receipt of the specific print jobs, the image forming control unit 4 (FIG. 5) controls the printer engine unit 5 (FIG. 5) to start the printing operation. In step S2-15, when the printing operation of the print jobs is completed, the process returns to step S2-2 to repeat the printing operation. When the printing operation of all of the print jobs stored in the image data storage memory 7 (FIG. 5) is completed, the process stops.

In step S2-16, the print priority setting unit 21-1 (FIG. 5) sets the print job selected by the operator in the printing order after the print job regenerated. In step S2-17, the image data control unit 21 (FIG. 5) reads the print data not printed in the print job interrupted, and sends the print data to the image forming control unit 4 (FIG. 5). Upon receipt of the print data, the image forming control unit 4 (FIG. 5) controls the printer engine unit 5 (FIG. 5) to resume the printing operation. Then, the process proceeds to step S2-15, and the process stops.

As described above, in the second embodiment, after the alarm is activated, when the print data not printed in the print job interrupted is small, it is possible to print the print data not printed first. Accordingly, while it is possible to select the print job to be resumed, it is possible to prevent the print job capable of being printed in a short period of time from being behind the following print jobs necessary for a long period of time for printing. As a result, the operator does not need to wait for completing the following print jobs, thereby improving printing operation efficiency.

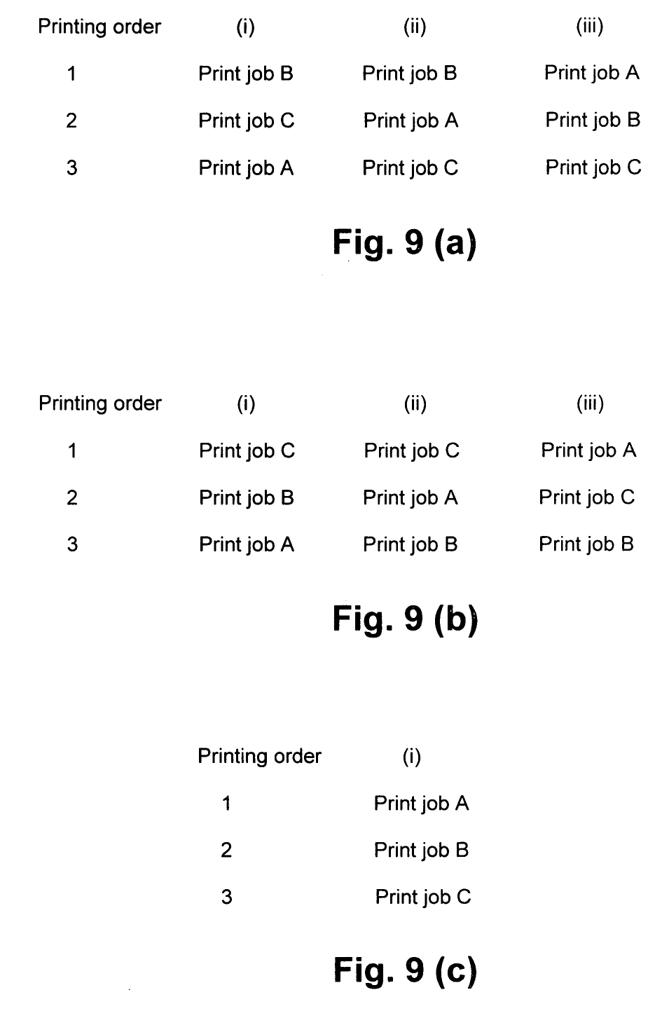

FIGS. 9(a) to 9(c) are views showing examples of the printing order. Suppose that print jobs A to C are assigned in the printing order at first, and the print job A is interrupted. When the operator selects the print job B to be resumed, two printing orders are possible as indicated as (i) and (ii) in FIG. 9(a). However, when pages not printed in the print job A are smaller than the limit page number, the printing order becomes (iii) in FIG. 9(a). Similarly, when the operator selects the print job B to be resumed, two printing orders are possible as indicated as (i) and (ii) in FIG. 9(b). However, when pages not printed in the print job A are smaller than the limit page number, the printing order becomes (iii) in FIG. 9(b). Further, when the operator selects the print job A to be resumed, the printing order becomes (i) in FIG. 9(c).

Third Embodiment

In the third embodiment, it is possible to switch on and off the job selection unit in the first and second embodiments. Hereunder, only differences from the first embodiment will be explained. Components same as those in the first embodiment are designated by the same reference numerals, and explanations thereof are omitted.

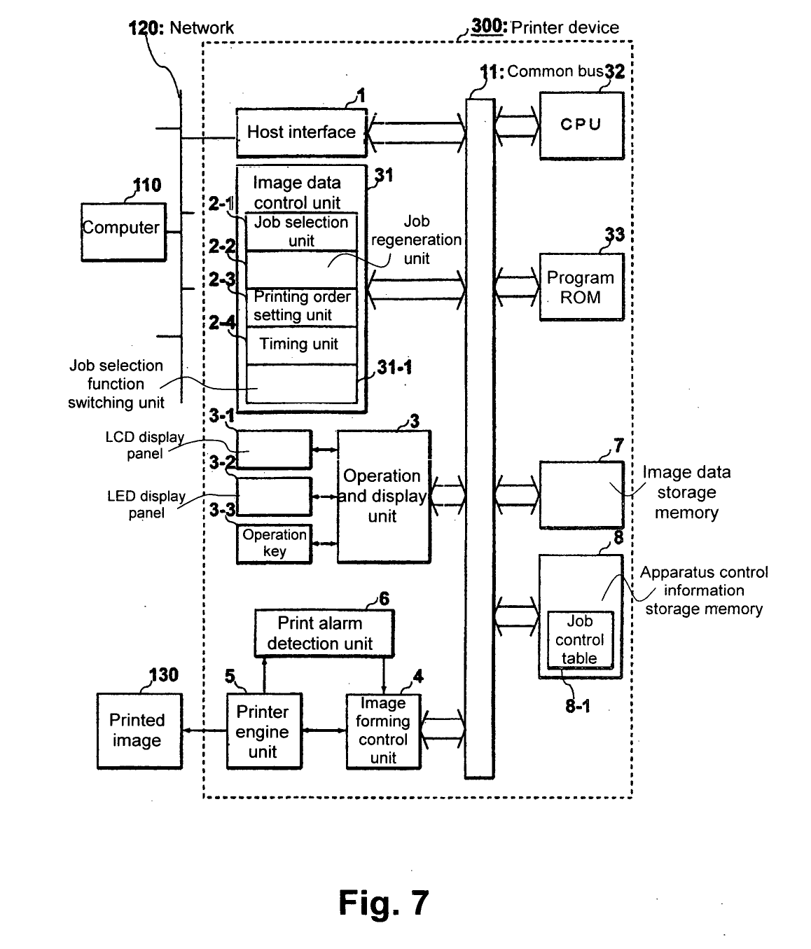

FIG. 7 is a schematic block diagram showing a printer device 300 according to the third embodiment of the present invention. As shown in FIG. 7, the printer device 300 includes the host interface 1; an image data control unit 31; the operation and display unit 3; the image forming control unit 4; the printer engine unit 5; the print alarm detection unit 6; the image data storage memory 7; the apparatus control information storage memory 8; a CPU 32; and a program ROM 33.

The image data control unit 31 monitors a print job, and includes the job selection unit 2-1; the job regeneration unit 2-2; the printing order setting unit 2-3; the timing unit 2-4 and a job selection function switching unit 31-1. The job selection unit 2-1 prompts an operator to select a print job to be resumed through the operation and display unit 3 after a print interruption cause is removed, and receives the selection. The job regeneration unit 2-2 regenerates one print job according to print data of a print job not printed when the print interruption cause is generated during the print job. The printing order setting unit 2-3 sets the print job regenerated according to the print data of the print job not printed in an order after a print job to be resumed when the job selection unit 2-1 selects the order of print jobs different from a specific printing order. The timing unit 2-4 measures a delay time until receipt of the selection when the job selection unit 2-1 prompts an operator to select a print job to be resumed through the operation and display unit 3. The timing unit 2-4 detects time-out after a specific period of time. The job selection function switching unit 31-1 switches the job selection unit 2-1 between effective and non-effective.

The image data control unit 31 writes and reads a print job into and from the image data storage memory 7, and transfers the print job to the image forming control unit 4. When the print alarm detection unit 6 detects a print interruption cause, the image data control unit 2 stops transferring the print job to the image forming control unit 4. The image data control unit 31 is started when the CPU 32 executes a specific control program stored in the program ROM 33. The print interruption cause includes no sheet, sheet jam, or the like, with which it is difficult to continue the printing operation. When the print interruption cause is removed, it is possible to resume the printing operation.

The CPU 32 is a microprocessor for controlling the whole apparatus. In the embodiment, the CPU 32 executes control programs stored in the program ROM 33 to start the image data control unit 31, the operation and display unit 3, and the image forming control unit 4.

The program ROM 33 is a read-only memory for storing the control programs to be executed by the CPU 32 for controlling the whole apparatus. In the embodiment, the CPU 32 executes the control programs stored in the program ROM 33 in advance to start the image data control unit 31, the operation and display unit 3, and the image forming control unit 4.

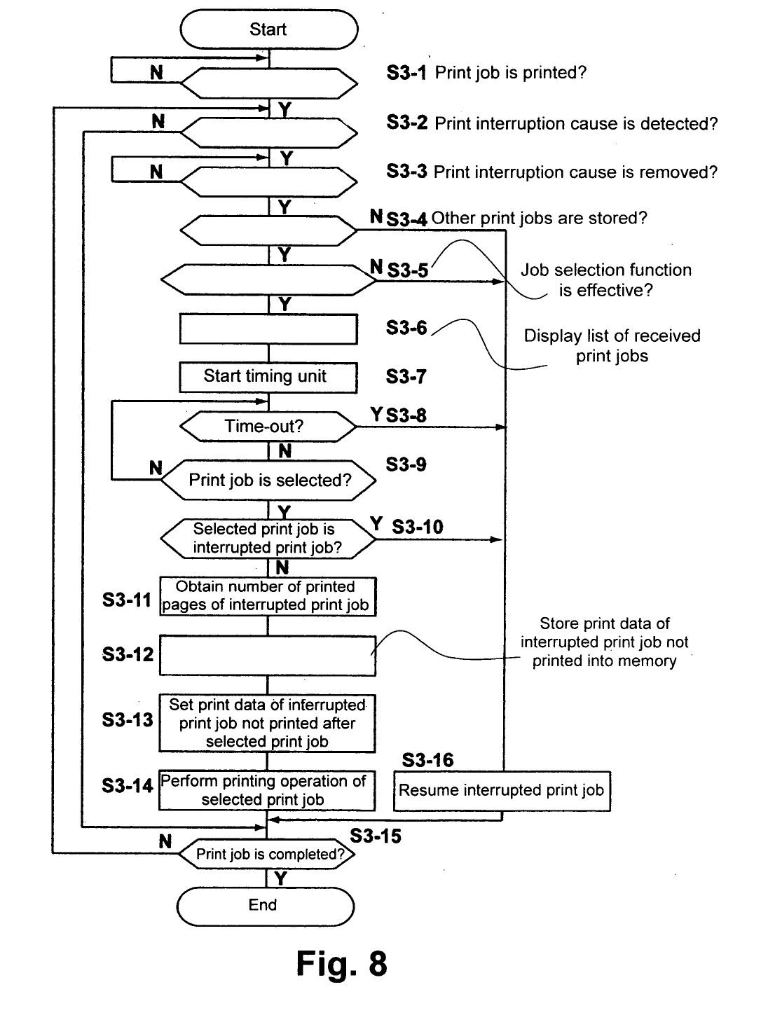

The printing operation of the printer device 300 according to the second embodiment is performed as follows. FIG. 8 is a flow chart showing the process of the printer device 300 according to the second embodiment of the present invention. The print operation of the printer device 300 will be explained in detail from step S3-1 to step S3-16.

In step S3-1, when the printer engine unit 5 (FIG. 7) performs specific print jobs in an order defined by the job control table 8-1 (FIG. 7), the process proceeds to step S3-2. In step S3-2, unless the print alarm detection unit 6 (FIG. 7) detects the print interruption cause during the printing operation, the process proceeds to step S3-15. When the print alarm detection unit 6 (FIG. 7) detects the print interruption cause, a notice of print interruption cause is sent to the image forming control unit 4 (FIG. 7), so that the image forming control unit 4 (FIG. 7) sends the alarm signal to the image data control unit 31 (FIG. 7) and the operation and display unit 3 (FIG. 7). Then, the process proceeds to step S3-3.

In step S3-3, the image data control unit 31 (FIG. 7) stops sending the print job, and waits for termination of the alarm signal. When the operator removes the print interruption cause according to the display of the operation and display unit 3 (FIG. 7), the print alarm detection unit 6 (FIG. 7) sends the removal notice of print interruption cause to the image forming control unit 4 (FIG. 7). Then, the image forming control unit 4 (FIG. 7) stops sending the alarm signal, and the process proceeds to step S3-4.

In step S3-4, the image data control unit 31 (FIG. 7) looks up the job control table 8-1 (FIG. 7) and determines whether other print jobs are stored in the image data storage memory 7 (FIG. 7). When other print jobs are not stored, the process proceeds to step S3-16. When other print jobs are stored, the process proceeds to step S3-5. In step S3-5, when the job selection function switching unit 31-1 switches the job selection unit 2-1 to effective, the process proceeds to step S3-6. When the image data control unit 31-1 switches the job selection unit 2-1 to non-effective, the process proceeds to step S3-16.

In step S3-6, the job selection unit 2-1 (FIG. 7) controls the operation and display unit 3 (FIG. 7) to display contents of the job control table 8-1 (FIG. 7) on the LCD display panel 3-1 (FIG. 7), and prompts the operator to select a print job to be resumed. In step S3-7, the timing unit 2-4 (FIG. 7) starts measuring the delay time until receipt of the selection of the print job to be resumed. In step S3-8, until the timing unit 2-4 (FIG. 7) becomes time-up, the process proceeds to step S3-9. When the timing unit 2-4 (FIG. 7) becomes time-up, the process proceeds to step S3-16.

In step S3-9, the process waits until receipt of the selection of the print job to be resumed. Upon receipt, the process proceeds to step S3-10. In step S3-10, when the print job selected is the print job interrupted due to the alarm, the process proceeds to step S3-16. Otherwise, the process proceeds to step S3-11.

In step S3-11, the job regeneration unit 2-2 (FIG. 7) obtains the number of pages already printed in the print job interrupted through the image forming control unit 4 (FIG. 7). In step S3-12, the job regeneration unit 2-2 (FIG. 7) regenerates a print job according to print data not printed in the print job interrupted, and stores the print job regenerated in the image data storage memory 7 (FIG. 7). At this moment, the print job interrupted is deleted from the image data storage memory 7 (FIG. 7) and the job control table 8-1 (FIG. 7).

In step S3-13, the printing order setting unit 2-3 (FIG. 7) sets the print job regenerated in the printing order after the print job selected from the print jobs other than the print job interrupted by the operator, and writes the print job regenerated into the job control table 8-1 (FIG. 7). In step S3-14, the image data control unit 31 (FIG. 7) reads the specific print jobs according to the job control table 8-1 (FIG. 7) set in step S3-13, and sends the specific print jobs to the image forming control unit 4 (FIG. 7). Upon receipt of the specific print jobs, the image forming control unit 4 (FIG. 7) controls the printer engine unit 5 (FIG. 7) to start the printing operation.

In step S3-15, when the printing operation of the print jobs is completed, the process returns to step S3-2 to repeat the printing operation. When the printing operation of all of the print jobs stored in the image data storage memory 7 (FIG. 7) is completed, the process stops. In step S3-16, the image data control unit 31 (FIG. 7) reads the print data not printed in the print job interrupted, and sends the print data to the image forming control unit 4 (FIG. 7). Upon receipt of the print data, the image forming control unit 4 (FIG. 7) controls the printer engine unit 5 (FIG. 7) to resume the printing operation. Then, the process proceeds to step S3-15, and the process stops.

When only a single operator uses the printer device, the job selection function is not necessary. In the third embodiment, with the job selection function switching unit, it is possible to switch off the job selection function, thereby improving the printing operation efficiency.

In the third embodiment, the job selection function switching unit is disposed in the printer device according to the first embodiment. The present invention is not limited thereto, and the job selection function switching unit may be disposed in the printer device according to the second embodiment.

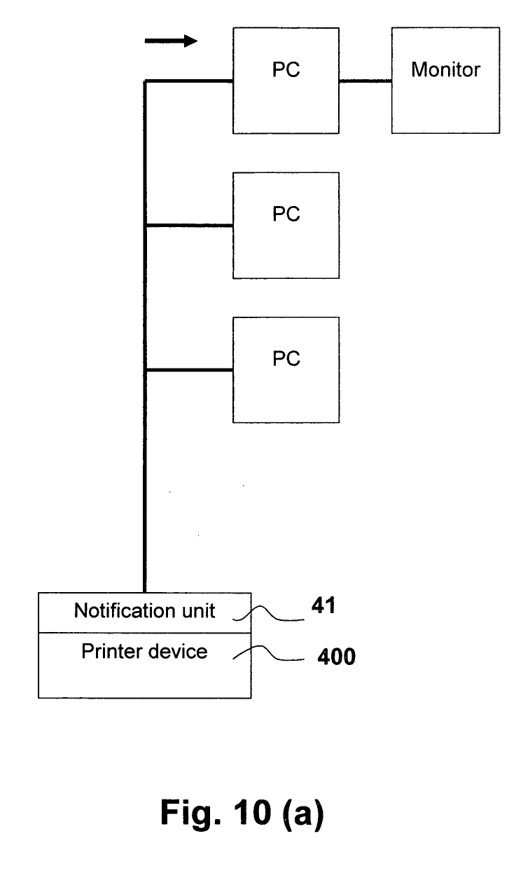

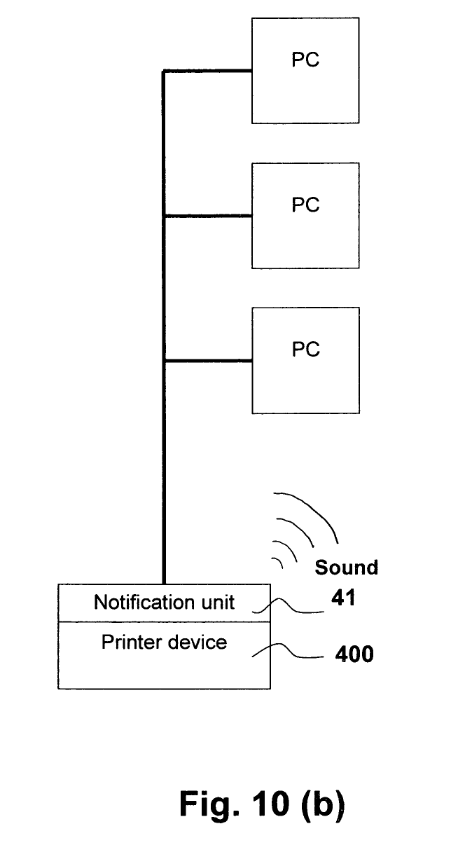

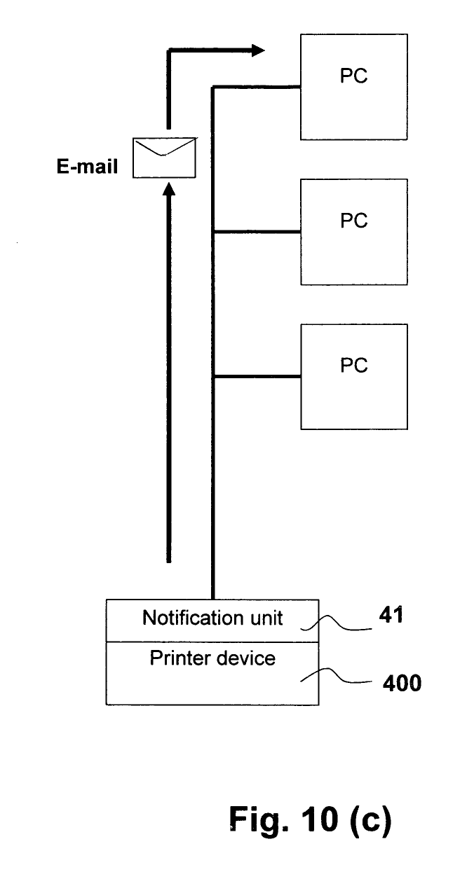

In the embodiments described above, several modifications are possible. For example, a notification unit may be disposed in the printer device for notifying the operation of the print interruption cause in various ways. FIGS. 10(a) to 10(c) are schematic views showing configurations of a printer device 400 having a notification unit 41. As shown in FIG. 10(a), the notification unit 41 may display the notice of the print interruption cause on a monitor of one of host computers PC. As shown in FIG. 10(b), the notification unit 41 generates sound for notifying the print interruption cause. As shown in FIG. 10(c), the notification unit 41 may sends an e-mail to one of the host computers PC.

Further, in each case shown in FIGS. 10(a) to 10(c), the notification unit 41 notifies the print interruption cause to an operator sending the print job interrupted or a host computer through which the operator sends the print job interrupted. Alternatively, the notification unit 41 may notify the print interruption cause to operators other than the operator sending the print job interrupted or host computers other than the host computer through which the operator sends the print job interrupted. Further, the notification unit 41 may notify the print interruption cause to a plurality of operators or host computers.

The disclosure of Japanese Patent Application No. 2005-171028, filed on Jun. 10, 2005, is incorporated in the application.

While the invention has been explained with reference to the specific embodiments of the invention, the explanation is illustrative and the invention is limited only by the appended claims.

What is claimed is:

1. An image forming apparatus for performing a printing operation in a first printing order having a first print job to be printed first, comprising:
a print alarm detection unit for detecting a print interruption cause;
a job selection unit for selecting a second print job to be resumed after the print interruption cause detected by the print alarm detection unit is removed;
a printing order setting unit for setting a second printing order having the second print job to be printed first when the second print job is different from the first print job; and
a printing unit for performing the printing operation.

2. The image forming apparatus according to claim 1, further comprising a job regeneration unit for generating a third print job according to print data not printed due to the print interruption cause.

3. The image forming apparatus according to claim 2, wherein said printing order setting unit sets the third print job after the second print job in the second printing order when the second print job is different from the first print job.

4. The image forming apparatus according to claim 2, further comprising a print priority setting unit for setting the third print job before the second print job when an amount of data of the third print job is smaller than a specific amount.

5. The image forming apparatus according to claim 1, further comprising a job selection function switching unit for switching on and off the job selection unit.

6. The image forming apparatus according to claim 1, wherein said print alarm detection detects the print interruption cause including at least one of sheet jam, no sheet, and no toner.

7. The image forming apparatus according to claim 1, further comprising a notification unit for notifying the print interruption cause.

8. The image forming apparatus according to claim 7, wherein said notification unit includes at least one of an LCD display panel and an LED display panel for displaying a notification thereon.

9. The image forming apparatus according to claim 7, wherein said notification unit includes a monitor of a host computer connected to the image forming apparatus for displaying a notification thereon.

10. The image forming apparatus according to claim 7, wherein said notification unit generates sound as a notification.

11. The image forming apparatus according to claim 7, wherein said notification unit sends an electric mail as a notification to a host computer connected to the image forming apparatus.

12. The image forming apparatus according to claim 7, wherein said notification unit notifies the print interruption cause to at least one operator sending a fourth print job with which the printing unit performs the printing operation when the print alarm detection unit detects the print interruption cause, or a host computer through which the operator sends the fourth print job.

13. The image forming apparatus according to claim 1, further comprising a display panel for displaying at least one of a file name, a host name, an IP address, a number of printed pages, a time when print data are sent, and a number of stored print jobs.

14. The image forming apparatus according to claim 13, wherein said display panel displays in an order that the print data are sent or printed.

15. The image forming apparatus according to claim 4, wherein said print priority setting unit sets the third print job before the second print job when the third print job includes one page.
